(19) United States
(12) Patent Application Publication
(10) Pub. No.: US 2024/0119430 A1
(43) Pub. Date: Apr. 11, 2024

(54) SYSTEMS AND METHODS FOR NETWORK MESSAGING INTEROPERABILITY BETWEEN DIFFERENT ZONES

(71) Applicant: VOCALINK INTERNATIONAL LIMITED, London (GB)

(72) Inventors: Andrew Buckley, Kenilworth (GB); Boy Anthony Kuhne, London (GB); Andrew John Moorley, Royston (GB)

(21) Appl. No.: 18/377,344

(22) Filed: Oct. 6, 2023

Related U.S. Application Data
(60) Provisional application No. 63/414,100, filed on Oct. 7, 2022.

(51) Int. Cl. G06Q 20/10; G06Q 20/40

(52) U.S. Cl. CPC G06Q 20/10; G06Q 20/405; H04L 67/56

(57) ABSTRACT

Systems and methods are provided for cross-border network messaging. An example computer-implemented method includes receiving, from a sending institution, a transfer request for a real time transfer from a sender to a recipient, where the transfer request includes an amount to be transferred and an identifier unique to the recipient. The sending institution is in a first zone having a first domestic currency and the recipient is in a second zone having a second domestic currency, and the amount is in the second domestic currency. The method also includes confirming that a liquidity of the sending institution in the first currency is sufficient and, in response to the confirmation, transforming the transfer request based on a rule specific to the second zone. The method includes transmitting the transformed transfer request to a core computing device in the second zone.

### CROSS-REFERENCE TO RELATED APPLICATION

This application claims the benefit of, and priority to, U.S. Provisional Application No. 63/414,100, filed on Oct. 7, 2022. The entire disclosure of the above-referenced application is incorporated herein by reference.

### FIELD

The present disclosure generally relates to systems and methods for use in facilitating network messaging to provide interoperability between multiple different zones (e.g., with regard to a transfer between the zones, etc.).

### BACKGROUND

This section provides background information related to the present disclosure which is not necessarily prior art.

Institutions are known to facilitate network messaging for various different purposes. Transferring funds is one such purpose, in which messaging is used to instruct the transfer of the funds from one account to another account. When the transfer of funds extends between different countries, the transfer may be referred to, for example, as a cross-border (or international or non-domestic) transfer. In connection therewith, the transfers may further involve different currencies, whereby an exchange of one currency for another is also included in the transfer. It is common for institutions involved in such cross-border transfers to partner or cooperate with institutions in other countries to facilitate the transfers in those regions.

### DRAWINGS

The drawings described herein are for illustrative purposes only of selected embodiments and not all possible implementations, and are not intended to limit the scope of the present disclosure.

FIG. 1 is an example system of the present disclosure suitable for use in providing network messaging between different zones;

FIG. 2 is a block diagram of an example computing device that may be used in the system of FIG. 1; and

FIG. 3 is an example method that may be implemented in the system of FIG. 1, or otherwise, for facilitating network messaging between different zones.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Cross-border transfers often require institutions (e.g., banks, etc.) involved in the transfers (or transactions) (e.g., sender institutions, etc.) to maintain or hold funds in each of the regions to which funds may be transferred (in respective currencies of the regions), or to rely on partner institutions in those countries to act on their behalf. What's more, cross-border transfers generally include delays (e.g., of several days, etc.), for example, due to the requirement for added network communications between different institutions in the different countries, multiple processes required to perform the transfers/transactions, limited operating hours, differing time zones, etc. The delays may be inefficient, time consuming and costly (e.g., cross-border transfers may cost five times or ten times as much as a domestic real time transfer, etc.).

Uniquely, in connection with cross-border transfers, the systems and methods herein provide for coordination of messaging between the different countries (broadly, different zones), through rules-based logic, to provide enhanced performance in the transfers (e.g., to provide real-time performance, etc.) and thus interoperability between the different countries. In particular, the systems and methods herein provide for real-time transfers (or real-time payment or RTP), between different jurisdictions or zones (e.g., different countries, etc.), in which a sender institution is not required to maintain liquidity in each of the foreign zones, but relies on pre-funded liquidity in the currency of the foreign zone (or jurisdiction) managed in a domestic zone which is leveraged to fund the transfer. In this manner, the transfer achieves a performance more akin to domestic real-time transfers in speed and cost.

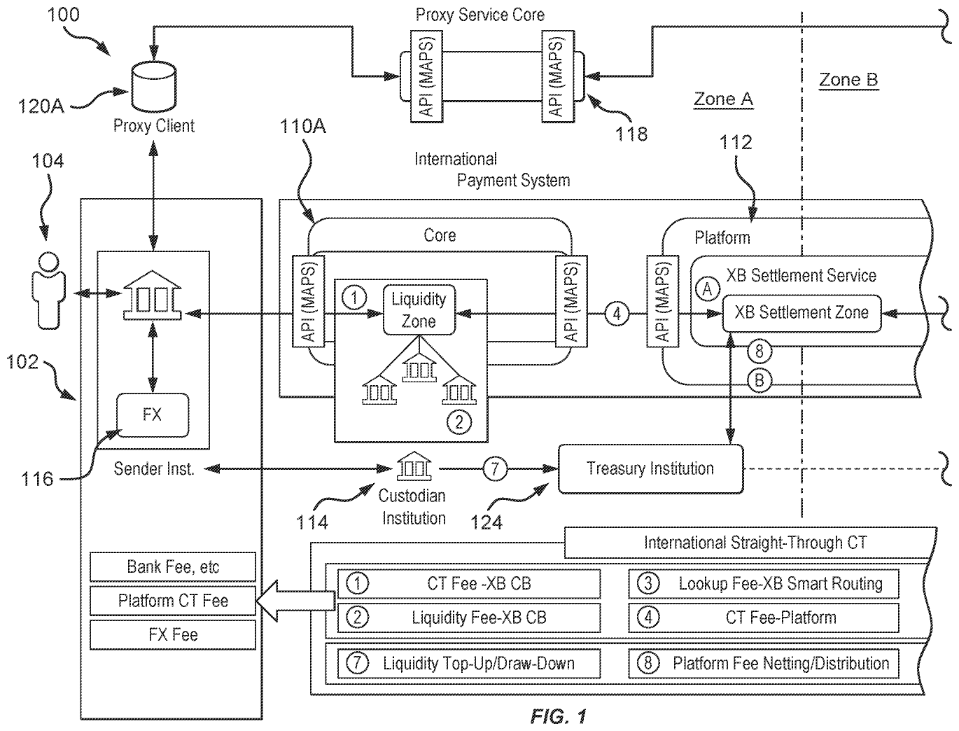

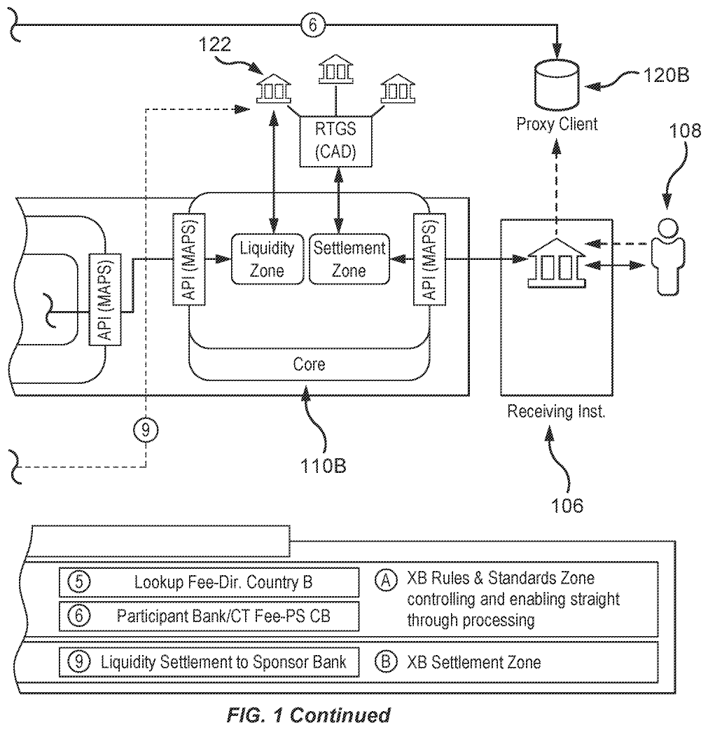

FIG. 1 illustrates an example system 100, in which one or more aspects of the present disclosure may be implemented. Although the system 100 is presented in one arrangement in FIG. 1, other embodiments may include systems arranged otherwise depending, for example, on a manner of messaging, standards employed in the networks, zone-based rules and regulations, privacy rules and regulations, etc.

In the illustrated embodiment, the system 100 generally includes a sender institution 102 associated with a sender user 104, a recipient institution 106 associated with a recipient user 108, multiple transfer cores 110A-B and a core transfer platform 112 coupled in communication therebetween. Each of the institutions 102, 106 in the system 100 may be understood to include a bank or other financial institution, in this example embodiment, which is configured to hold funds in accounts, in general or on behalf of users (or other institutions), and to transfer the funds as directed by the users (or other institutions), or in connection with transfers directed by users, etc.

It should be appreciated that the institutions 102, 106 may be involved in other transfers with each other or other institutions, whereby the sender institution 102 may also be a recipient institution in connection with certain transfers and the recipient institution 106 may be a sender institution for certain transfers.

It should also be appreciated that the institutions 102, 106, the cores 110A-B and the core platform 112 in the system 100 are each coupled to (and in communication with) one or more communication networks. The one or more communication networks are represented in FIG. 1 by the various arrowed lines and each may include, without limitation, a local area network (LAN), a wide area network (WAN) (e.g., the Internet, etc.), a mobile network, and/or another suitable public and/or private network capable of supporting communication among two or more of the parts illustrated in FIG. 1, or any combination thereof.

It should further be appreciated that the core 110A-B and the platform 112 may combine to provide an international payment system (as noted in FIG. 1), which is configured to support real-time transactions (and transfers), as described herein. The payment system may be separate from other payment systems, or potentially integrated therewith, in whole or in part. For example, the illustrated payment system (e.g., as provided by the cores 110A-B and the platform 112, etc.) may be integrated with a conventional credit transaction processing network to, for example, leverage common resources, integration and/or connectivity among the payment systems/networks.

In this example embodiment, the core platform 112 and the core 110A, for example, may be integrated and/or incorporated into a processing network (e.g., the MASTERCARD network, etc.), while the core 110B may be integrated and/or operated by a different entity. In at least one example, the core 110B may include a real-time payment service in zone B, with which the core platform 112 is configured to perform/interact, consistent with the disclosure herein. Additionally, or alternatively, the platform 112 along with each of the cores 110A-B may be integrated and/or incorporated into a same processing network.

As shown in FIG. 1, the system 100 is disposed across two zones: zone A and zone B. The zones A and B may be different states, territories, countries, or other suitable divisions (e.g., based on physical boundaries, geo-political boundaries, etc.), etc. In general, the zones A and B are each defined by laws, agreements, borders, or otherwise, etc., and are associated with a standard currency (one or more of which is potentially different from the other). In this example embodiment, a first standard currency is used in zone A, and a second, different standard currency is used in zone B. For example, zone A may include the United States with a currency of United States dollars (USD), while region B may include Canada with a currency of Canadian dollars (CAD). Consequently, then, a transfer between a user in zone A with a user in zone B is not only a cross-border transfer, but also a cross-currency transfer. As shown in FIG. 1, the institution 102 and the core 110A are located in zone A, and the institution 106 and the core 110B are located in zone B. The core platform 112 is illustrated in both of zones A and B, in that the core platform 112 may be located in either of the zones A and B (or in both of the zones). For example, the core platform 112 may be located in zone A or in zone B, depending on, for example, regulatory requirements (e.g., data or privacy protection, etc.).

In addition, it should be appreciated that other systems may include various additional zones, whereby real time transfers may be between different ones of the additional zones, but generally consistent with the description herein relative to zones A and B. For example, the core platform 112 may be the same, but one or more additional transfer cores may be deployed to each of the additional zones. In this manner, the payment is extended to the additional zones, and may, for example, be integrated with other payment systems in zones A and B, and potentially, other zones, etc.

In zone A, the core 110A is associated with a custodian institution 114 located in zone A. Similar to the institution 102, for example, the custodian institution 114 includes a bank or other financial institution, in this example embodiment, which is configured to hold funds in accounts. In particular, in this example, the custodian institution 114 is configured to issue an account, which includes funds in currencies associated with other zones. Specifically, the custodian institution 114 is associated with an account, which controls (e.g., holds or otherwise manages, etc.) an amount of funds in CAD or the currency of zone B (as compared to USD for the zone A) (e.g., through a relationship or common ownership with a bank in zone B (e.g., where the funds are held in either zone A or in zone B, etc.), etc.). In this manner, the sender institution 102 is permitted to manage (or otherwise access or have access to, etc.) funds in (or associated with) the account (of/at the custodian institution 114), whereby the sender institution 102 is associated with pre-funded liquidity in the currency (i.e., different than the domestic currency). It should be appreciated that the custodian institution 114 may be configured to hold/issue accounts of various other currencies, whereby an account for each of the dozen, hundreds or more or less most use currencies may be issued/held by the custodian institution 114 for transfers associated therewith. The accounts are then general to the currency and not to any particular institution, whereby a liquidity zone of the core 110A (as shown in FIG. 1) is further configured to maintain a ledger of the transfer into and out of the account by each institution, such as, for example, the sender institution 102. The liquidity zone of the core 110B may be configured, in at least one example, to maintain the ledger as a blockchain or other immutable ledger, or still other types of data structure in other examples. It should be appreciated that in one or more embodiments, the custodian institution 114 may be configured to maintain a ledger to manage transfer into and out of the account by each institution.

In this example embodiment, the system 100 also includes a proxy platform (or proxy service), which includes a proxy service core 118 (located in zone A (and another proxy service core also, potentially, in zone B)) and proxy clients 120A-B, located in zone A and zone B, respectively, as illustrated in FIG. 1 It should be understood that the proxy service core 118 may be integrated, in whole or in part, with the platform 112 in one or more embodiments. In this example embodiment, as shown in FIG. 1, multiple API interconnections are illustrated as an example method of communication between different parts of the system 100. In particular, MASTERCARD MAPS tools are employed, which is configured, as an adapter or transformation, to provide connectivity and/or messaging between different type of connections and/or message formats (e.g., languages, etc.). It should be appreciated that other types of interconnection may be employed among the different parts of the system 100.

As in FIG. 1, the system 100 includes multiple banking institutions 122 located in zone B and a treasury institution 124 located in zone A. The multiple banking institutions 122 provide for liquidity in zone B, as explained below, and the treasury institution 124 is configured to coordinate settlement for transfer between the zones A, B in FIG. 1. On example treasury institution in the United States, for example, may include The Clearing House Payment Company, L.L.C., etc.

In connection with the above, in an example implementation, the sender user 104 intends to send an amount of funds to the recipient user 108. As such, the sender user 104 submits, to the institution 102, a transfer request including a proxy for the recipient user 108 and an amount to be transferred (e.g., in USD or CAD, etc.). In particular in this example, the request includes a specific request for a real time transfer/payment (RTP), for which the transfer or payment is initiated and settled within minutes (as compared to days in conventional payments), whereby the transfer is perceived (e.g., by the users 104, 108, etc.) to be instantaneous. It should be appreciated that in one or more embodiments, the sender user 104 may provide account data in the request, whereby the proxy and proxy resolution as described below, may be omitted.

The institution 102, in turn, is configured to submit the proxy to the proxy client 120A in zone A. Upon receipt of the request, the proxy client 120A in zone A is configured to check for the proxy included in the request, and when not found (and potentially based on rules associated with the proxy) is configured to forward the request (including the proxy) to the proxy service core 118. Upon receipt of the request, the proxy service core 118 is configured to solicit account data from the clients in other zones, including zone B (based on the format and/or content of the proxy) (e.g., via a proxy service core in that zone, etc.). The proxy client 120B in zone B, in this example, is configured to locate the account data, based on the proxy, and to return the account data to the proxy service core 118, which is configured to return the account data to the sender institution 102, via the data structure in zone A. The specific proxy request and/or account data is described in more detail in U.S. Provisional App. 63/406,542, filed Sep. 14, 2022, which is incorporated herein by reference. That said, it should be appreciated that other flows and/or interactions by and between the proxy clients and proxy service core may be used to resolve the proxy and return the account data to the institution 102.

Based on the account data, and potentially, the proxy, the institution 102 is configured to then identify the transfer as a cross-board transfer. In some examples, where the user 104 has already indicated that the transfer is a cross-border transfer, the institution 102 may be configured to verify the account data, via the proxy service, for example, as described.

In turn, the institution 102 is configured to request a quote for currency conversion to a foreign exchange (FX) provider 116, as shown in FIG. 1, which may be internal to the institution 102 or external thereto. The FX provider 116 is configured to determine and return a cost of transfer. The cost of the transfer includes the amount of the transfer in the currency in which the account of the recipient 108 is issued (i.e., the currency of institution 106, or CAD) and any associated fees for the transfer by the FX provider 116, the institution 102, the core platform 112 (or cores 110A, 110B), etc. The FX provider 116 is configured to return the cost of transfer to the institution 102, which is configured to submit the cost to the user 104 for acceptance.

Once accepted by the user 104, the institution 102 is configured to confirm an available balance of the user 104 to cover the transfer and to perform certain checks, including, for example, anti-money laundering (AML) and know-your-customer (KYC) rules and/or regulation checks, sanction list checks, etc., to confirm the appropriateness of the transfer. Additionally, or alternatively, the institution 106 may optionally be configured to perform certain checks, including, for example, anti-money laundering (AML) and know-your-customer (KYC) rules and/or regulation checks, sanction list checks, etc. to confirm the appropriateness of the transfer (e.g., as part of the proxy flow, etc.) (e.g., in connection with the proxy service, etc.).

The institution 102 is configured to then submit the transfer (in the currency CAD, in this example) to the core 110A located in zone A. At this point or later, in one or more examples, the core 110A may be configured to verify the transfer request (e.g., based on form, format, content, etc.), and when verified, the core 110A (or more particularly, the liquidity zone thereof) may be configured to check the balance of CAD for the institution 102 at the custodian institution 114. When sufficient funds exists, the core 110A is configured to reserve the funds for the transfer and to submit the transfer to the core platform 112.

The core platform 112, in turn, is configured to forward the transfer request to the core 110B located in zone B. In doing so, the platform 112 is configured to transform the transfer request, and as necessary or desired, to conform to rules, regulations, and/or preferences of zone B, the core 110B or institutions located in zone B, etc. In one example, the core platform 112 may be configured to confirm all required data is included in the transfer request and/or that the amount is within the allowance per transaction in zone B. Further, in another example, when the amount exceeds the per transaction threshold, the core platform 112 may be configured to modify and/or reject the transfer, as appropriate. It should be appreciated that various different rules may apply to transfers between zone A and zone B, and between zone A and various other zones, whereby the core platform 112 may include different rules to be imposed for different zones.

Upon receipt of the transfer request(s), from the core platform 112, the core 110B is configured to verify the transfer request (as described above) and to verify the liquidity of the sending institution 102, via one of the institutions 122 (which is associated with the CAD liquidity of the institution 102). Stated another way, the institution 122 is configured to determine whether the sending institution 102 has sufficient liquidity in the particular currency (e.g., CAD, etc.) (or the zone A has sufficient liquidity, more generally) to satisfy the transfer. The core 110B then is configured to clear the transfer with the recipient institution 106, whereby the funds are directed to the account associated with the account data included in the transfer request, i.e., the account of the recipient 108 issued by the recipient institution 106. In connection therewith, the core 110B is configured to update a settlement record to include the transfer, at the institution 122.

The recipient institution 106 is configured to submit a confirmation message to confirm the transfer to the core 110B, whereupon the core 110B is configured to verify the confirmation message and to credit the account of the recipient institution 106 for the amount of the transfer. The core 110B is further configured to commit the transfer, via the institution(s) 122, and to submit a transfer response indicative of the commitment to the core platform 112.

In this example embodiment, the core platform 112 is configured to transform the transfer response, as necessary or desired. For example, the core platform 112 may be configured to combine transfer responses (when the original transfer request was separated by the core platform 112). The core platform 112 is configured to then verify the transfer response (e.g., based on form, format, and/or content, etc.), and to commit the transfer to the treasury institution 124. The core platform 112 is configured to submit a confirmation message for the clearing and settlement of the transfer to the core 110A. In connection therewith, the core platform 112 may be configured to transform or translate the confirmation as necessary or desired, for example, to conform to the payment system in zone A, etc.

The core 110A is configured to verify the confirmation message (e.g., based on form, format, and/or content, etc.) and to confirm the commitment to the transfer to the sender institution 102.

In response, the sender institution 102 is configured to debit the funds for the transfer, if not done already, and further, the FX provider 116 (whether as part of the institution 102 or external thereto) is configured to replenish the CAD balance at the custodian institution 114, as needed and/or per interval (e.g., once per day, one per period, once per week, etc.).

In this example embodiment, the liquidity zone of the core 110A is configured to adjust the balance of the CAD account of the sender institution 102 based on the transfer. Consistent therewith, the available cross-border balance associated with the core 110B (e.g., at the institution(s) 122, etc.) indicates the transfer. Further, the core platform 112 is configured to issue a settlement instruction for the transfer (and other transfers, potentially), to the treasury institution 124. The treasury institution 124 is configured to claim the transfer amount from the custodian institution 114 and to settle the transfer with the institution(s) 122 in zone B.

It should be understood that in FIG. 1, while zone A is the sender zone and zone B is the recipient zone, the zones may be reversed for other transfers whereby the core 110A is configured to include a settlement zone to settle the transfer and the core 110B is configured to initiate the transfer. It should be further appreciated that many more zones may be included in other systems embodiments, whereby one or more additional core platforms reside between the different cores in the different zones, and whereby each core is configured similar to one or more of the cores 110A-B. In this manner, the system 100 is configured to facilitate real time transfers across the multiple zones, based on the description therein.

In connection with the above, the core platform 112 is configured to control and check fees that are generated, incurred, or imposed in the system 100, for example, as illustrated by numbers (1) through (9) in FIG. 1 (across zones A and B). In this manner, the core platform 112 is configured to provide clarify of fees for the transfer at the outset, whereby the sender user 104 (and potentially, the sender institution 102) is permitted to be informed about the fees (associated with the straight-through processing of the transfer), and further, to integrate fee payments by the various institutions/parties into the settlement of the transfer. Further, these fees should be understood to be optional, whereby one, some, or all of the fees may be omitted, or controlled by another entity, institution, etc.

As shown, fees are associated with and/or provided by the core platform 112, to allow straight-through processing of the cross-border transfers and/or transaction, when initiated, and finally distributing the broken down fees accordingly via the settlement zone of the core platform 112.

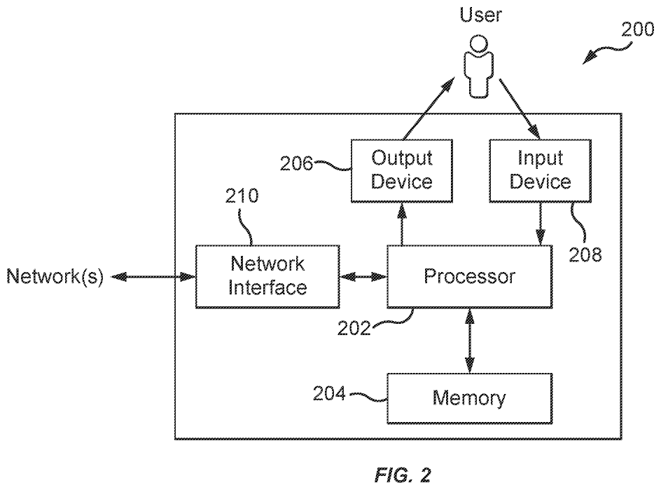

FIG. 2 illustrates an example computing device 200 that can be used in the system 100. The computing device 200 may include, for example, one or more servers, workstations, personal computers, POS terminals, laptops, tablets, smartphones, PDAs, virtual devices, etc. In addition, the computing device 200 may include a single computing device, or it may include multiple computing devices located in close proximity or distributed over a geographic region as a network of computing devices, so long as the computing devices are specifically configured to function as described herein. In particular, in the example system 100 of FIG. 1, each of the institutions 102, 106, 122, 124, the proxy service core 118, the proxy clients 120A, B, the cores 110A, B, the platform 112, the FX provider 116, etc., should be understood as being implemented in (and/or otherwise including) one or more computing devices generally consistent with or at least partially consistent with the computing device 200. That said, the system 100 should not be considered to be limited to the computing device 200, as described below, as different computing devices and/or arrangements of computing devices may be used in other embodiments. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, proxies, rules, liquidity balances, and/or other types of data (and/or data structures) suitable for use as described herein. Furthermore, in various embodiments, executable instructions may be stored in the memory 204 for execution by the processor 202 to cause the processor 202 to perform one or more of the operations described herein (e.g., one or more of the operations described in method 300, etc.), such that the memory 204 is a physical, tangible, and non-transitory computer readable storage media. Such instructions often improve the efficiencies and/or performance of the processor 202 that is performing one or more of the various operations herein, whereby the instructions (when performed by the processor 202) effectively transform the computing device 200 into a special purpose device configured to perform the unique and specific operations described herein. It should be appreciated that the memory 204 may include a variety of different memories, each implemented in one or more of the functions or processes described herein.

In addition in the example embodiment, the computing device 200 includes a presentation unit 206 that is coupled to (and is in communication with) the processor 202 (however, it should be appreciated that the computing device 200 could include output devices other than the presentation unit 206, etc.). The presentation unit 206 outputs information (e.g., a solicitation to confirm a transfer amount and/or quote for the transfer, etc.), either visually or audibly, to a user of the computing device 200, etc. And, various interfaces (e.g., as defined by applications, webpages, etc.) may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 may include multiple devices.

The computing device 200 also includes an input device 208 that receives inputs from the user of the device (i.e., user inputs) such as, for example, amounts and/or proxies associated with transfer requests, etc. The input device 208 is coupled to (and is in communication with) the processor 202 and may include, for example, a keyboard, a pointing device, a mouse, a touch sensitive panel (e.g., a touch pad or a touch screen, etc.), another computing device, and/or an audio input device. Further, in various example embodiments, a touch screen, such as that included in a tablet, a smartphone, or similar device, may behave as both the presentation unit 206 and the input device 208.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to/with one or more different networks, including one or more of the networks in FIG. 1. Further, in some example embodiments, the computing device 200 may include the processor 202 and one or more network interfaces (including the network interface 210) incorporated into or with the processor 202.

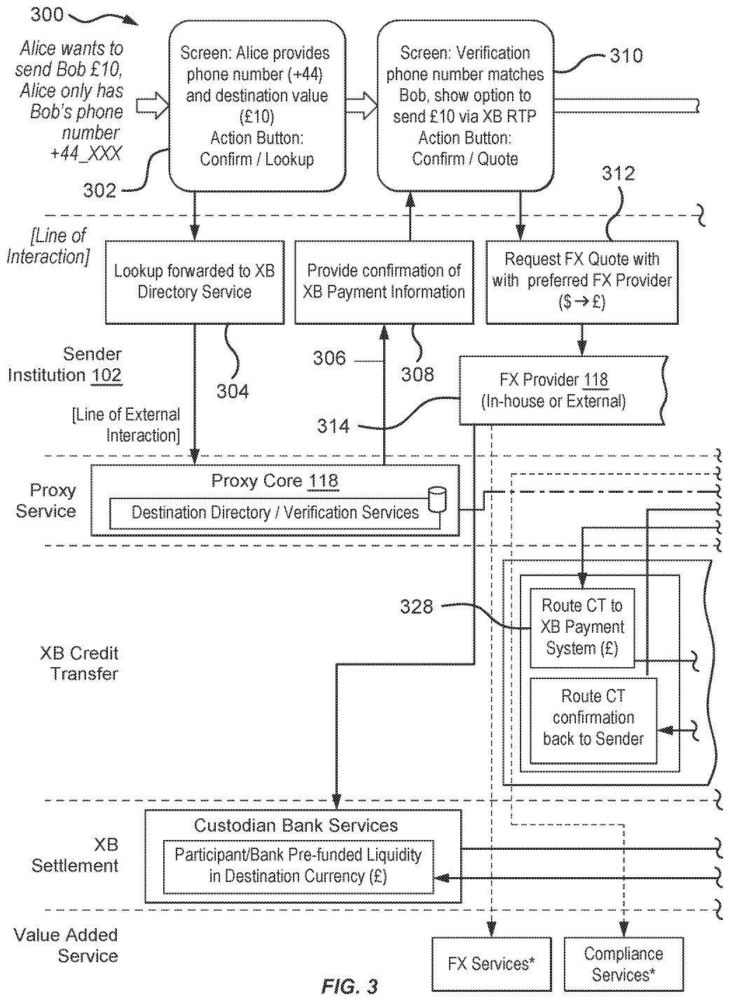

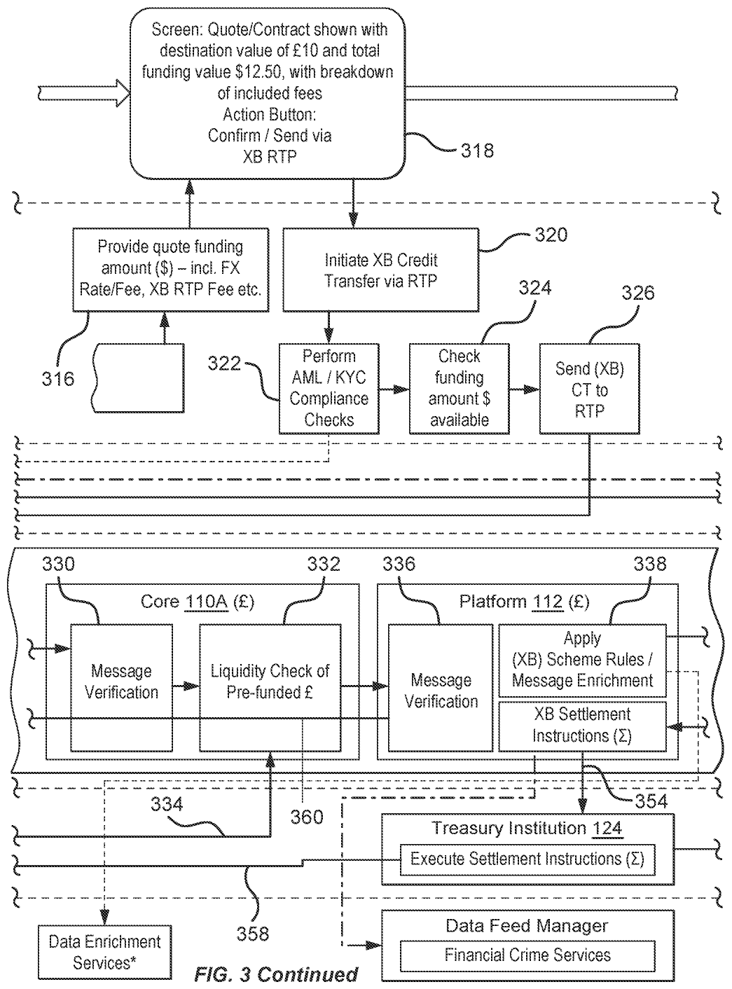

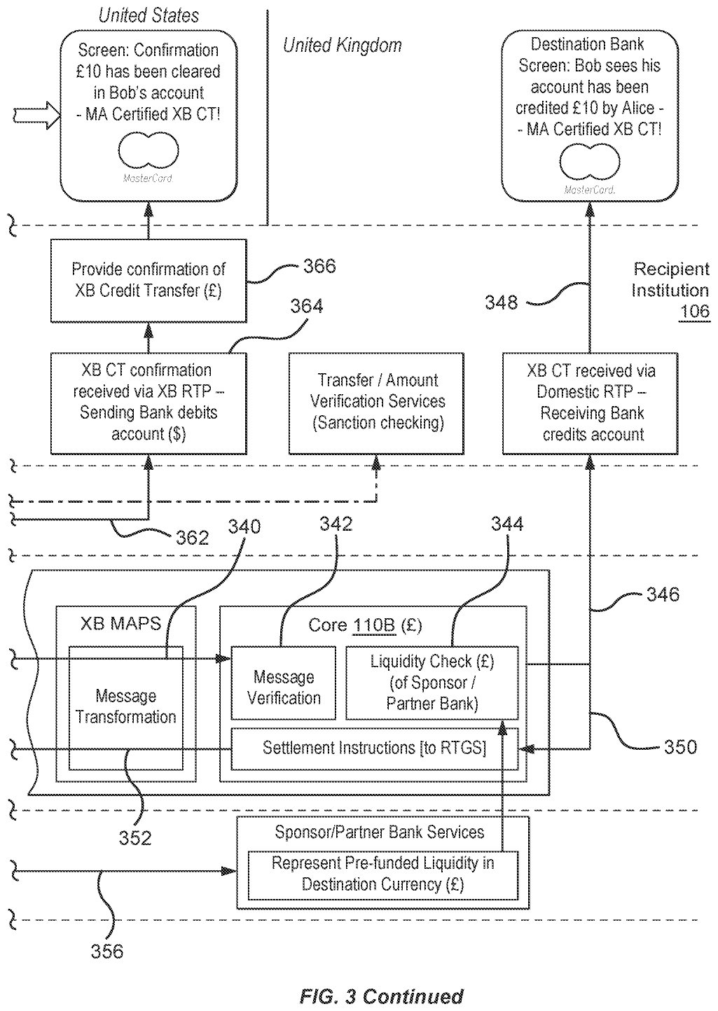

FIG. 3 illustrates an example method 300 for use in facilitating a cross-border, or cross-currency, transaction. While the method 300 is generally consistent with the above description of the operation of the system 100, as including the computing device 200, it should be appreciated that the methods herein are not limited to the system 100, or computing device 300. And, likewise, the systems and computing devices described herein are not limited to the example method 300.

At the outset, in this specific example embodiment, Alice wants to send a real time payment to Bob in the amount of £10, based on Bob's phone number, which is represented by +44_XXX (i.e., having country code for United Kingdom). Alice is located in the United States, and the sender institution 102 is also located in the United States. In connection therewith, Alice may access a mobile application on a mobile device (e.g., mobile phone, tablet, etc.), and also indicate a desire to transfer funds. In response, the mobile device displays a screen to Alice, which solicits an amount of a transfer and a proxy of the recipient, Bob (e.g., the phone number for Bob, an email address, or other unique identifier, etc.). Alice then enters the phone number for Bob, represented by +44_XXX, and the amount of the transfer in the destination currency (e.g., pounds, etc.) (or potentially, in a domestic currency). In response, the mobile device (not shown) submits, at 302, a transfer instruction to the sender institution 102. Again, it should be appreciated that proxies other than phone numbers may be used in other examples (e.g., email addresses, other unique identifiers for users, etc.).

It should be further appreciated that in one or more embodiments, Alice may have account data for Bob, and submit the account data in lieu of the proxy, whereby the proxy resolution described below, may be omitted. Alternatively, the proxy and the account data may be submitted by Alice, whereby the proxy is used, as described below, to verify the account data provided by Alice.

The sender institution 102 submits, at 304, the phone number as the proxy to the proxy service in the United States. Upon receipt of the instruction, the proxy client 120A in the United States determines the proxy is associated with a foreign zone and submits the proxy to the proxy service core 118 as a proxy lookup request. The proxy service core 118 determines that the phone number is associated with the United Kingdom, in this example, based on the +44 country code and submits the proxy lookup request to the proxy client 120B (in this example) located in the United Kingdom (e.g., via a proxy service core in zone B (not shown), etc.). The proxy client 120B, in turn, returns account data associated with the proxy to the proxy service core 118 (e.g., via a proxy service core in zone B (not shown), etc.). It should be appreciated that the proxy resolution may extend to the institution 106, in zone B, whereby the institution 106 may optionally perform one or more of the compliance checks described herein. Next, the proxy service core 118 returns the account data to the sender institution 102, at 306, via the proxy client 120A in the United States. The account data may include a name, address, account number, recipient institution name and/or identifier, etc. It should be appreciated that the proxy lookup request may be managed otherwise by the proxy service in other examples, as indicated above.

At 308, the sender institution 102 provides confirmation of the cross-border transfer to Alice, whereupon Alice's mobile device displays a screen indicative of certain transfer information (e.g., name and a residency of Bob or “Bob located in London, UK”) to Alice. Other data, generally, would not be provided to Alice, such as, for example, an account number, etc. In this manner, Alice is able to confirm the request, at 310.

The sender institution 102 then requests, at 312, a currency conversion quote for the transfer (i.e., USD to Pounds in this example) from the FX provider 116, which is either internal to or external from the sender institution 102. The FX provider 116 then determines and provides, at 314, the currency conversion quote, which includes the amount of the transfer in dollars along with any associated fees for the FX provider 116 (and potentially any fees for other services and/or parties involved therein), etc. As shown in FIG. 3, the FX provider 116 may be in the form of a value-added service from one or more service providers (e.g., MASTERCARD network, etc.). The sender institution 102 provides the total funding quote for the transfer (e.g., $12.14USD, etc.) (as defined by the FX provider 116 and any additional fees from the sender institution 102 (e.g., cross-border fees, etc.)) to Alice, at 316. The mobile device displays the transfer quote to Alice, and Alice, at 318, confirms permission to proceed with the transfer.

In turn, the sender institution 102 initiates, at 320, the cross-border transfer request from Alice to Bob. In connection therewith, at 322, the sender institution 102 performs compliance checks related to, for example, anti-money laundering, know your customer requirements, etc. The compliance checks may be based on the account data received from the proxy service, including, without limitation, checks as to Bob and checks as to the recipient institution 106. Various ones of the checks, for example, may be provided through one or more third party services. As shown in FIG. 3, for example, one or more compliance services provided as value-added services may be employed in the method 300, from one or more service providers (e.g., the MASTERCARD network, etc.).

At 324, the sender institution 102 checks the balance of Alice's account, as issued by the sender institution 102, to confirm sufficient balance is present to satisfy the transfer (e.g., an amount greater than the transfer quote, etc.). And, when the checks are passed, at 326, the sender institution 102 sends the cross-border transfer request to the payment system, via an API call, for example. The payment system receives the request and forwards the request to the core 110A, as a cross-border transfer request, at 328.

At 330, the core 110A verifies the transfer request, for example, based on form, format, content, etc. At 332, the core 110A checks the liquidity of the sender institution 102 with the custodian institution 114. The custodian institution 114 confirms, at 334, the liquidity for the sender institution 102 when the balance of the institution's holding in pounds exceeds the amount of the transfer. The core 110A then submits the transfer request (after verification and confirmation check) to the platform 112 of the payment system. The platform 112 verifies, at 336, the transfer request, for example, based on form, format, content, etc.

Then, when verified, the platform 112 applies cross-border rules and/or enrichments to adjust, modify or alter (broadly transform) the transfer request, as necessary or desired, at 338. The rules may indicate a transfer limit per transaction, required data/information, etc., whereby the rules may be specific to the zone to which the transfer is directed (e.g., zone B, etc.), specific to multiple zones, or generic to all zones, etc. The platform 112 may take action consistent with the rules to permit, reject or modify the transfer request. As shown in FIG. 3, further, the enrichment of the transfer request may be performed as a value-added service from one or more service providers (e.g., MASTERCARD network, etc.). Enrichment services may include, for example, supplementing the transfer request with required data/information, etc.

Thereafter, at 340, the platform 112 submits the transformed transfer request(s) to the core 110B, via an API call, for example.

At 342, the core 110B verifies the transfer request, for example, based on form, format, content, etc., and performs, at 344, a liquidity check in pounds through one of the institutions 122, in this example, where the liquidity is associated with the custodian institution 114 (e.g., by agreement, ownership, or otherwise, etc.). It should be appreciated that other sources of checking liquidity may be employed in other embodiments. Once the liquidity is confirmed, the core 110B provides the transfer request to the recipient institution 106 in the United Kingdom, at 346.

The recipient institution 106 provides a confirmation of the transfer to Bob, at a mobile device associated with Bob (not shown), at 348. And, then, at 350, the recipient institution 106 provides a confirmation of clearing (i.e., between the one of the institutions 122 and the recipient institution 106 in pounds). Then, the core 110B creates a settlement instruction in zone B and issues a confirmation of the clearing/transfer to the platform 112 of the payment system, at 352.

The platform 112 then creates a settlement instruction, at 354, based on the confirmation, and issues the instruction to the treasury institution 124. The treasury institution 124 then issues settlement instructions, at 356 (e.g., as part of a settlement service, etc.), whereby the total settlement sum is claimed from the custodian institution 114, and at 358, whereby the claimed funds are delivered, assigned, or paid to the one of the institutions 122. The platform 112 then informs the core 110A of the settlement of the transfer, at 360, whereby the core 110A informs, at 362, the sender institution 102 of the settlement of the transaction. In turn, the sender institution 102 debits the amount in USD from an account associated with Alice, at 364. The sender institution 102 then confirms, at 366, the transfer to Alice, via a confirmation at Alice's mobile device, as indicated in FIG. 3.

In view of the above, the systems and method herein provide a technical solution for cross-border real time transfers, where such cross-border transfers limit the requirements on sender institutions in foreign zones, while ensuring compliance with associated rules, regulations, etc.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the operations recited in the claims and/or otherwise recited herein.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for cross-border network messaging, the method comprising:
receiving, by a computing device of a payment system, from a sending institution, a transfer request for a real time transfer from a sender user to a recipient user, the transfer request including an amount to be transferred and an identifier unique to the recipient user, the sending institution located in a first zone having a first domestic currency and the recipient user located in a second zone having a second domestic currency, the amount in the second domestic currency of the second zone;
confirming, by the computing device, a liquidity of the sending institution in the first currency with a custodian institution is sufficient to cover the amount included in the transfer request;
in response to the confirmation, transforming, by the computing device, the transfer request based on one or more rules, the one or more rules specific to the second zone; and
transmitting, by the computing device, the transformed transfer request to a core computing device located in the second zone, whereby the core computing device provides the transformed transfer request to a recipient institution located in the second zone and associated with the recipient user.

2. The computer-implemented method of claim 1, wherein the identifier unique to the recipient user includes a proxy; and
further comprising:
submitting the proxy to a proxy client, thereby permitting the proxy client to submit the proxy to a proxy service core in the first zone to communicate with another proxy service core in the second zone; and
in response to submitting the proxy, receiving, from the proxy service core in the first zone, via the proxy client, account data specific to the proxy.

3. The computer-implemented method of claim 1, wherein the identifier unique to the recipient includes account data.

4. The computer-implemented method of claim 1, wherein the identifier unique to the recipient includes a proxy, the proxy including a phone number for the recipient user.

5. The computer-implemented method of claim 1, further comprising:
receiving a transfer instruction from the sender user;
in response to the transfer instruction and in connection with a commitment by the sending institution to pre-fund the transfer to the recipient user in the second zone, requesting, by the sending institution, a currency conversion quote from a foreign exchange (FX) provider;
receiving the currency conversion quote from the FX provider; and
submitting, by the sending institution, the transfer request to the payment system, the amount of the transfer request including an amount of the currency conversion quote.

6. The computer-implemented method of claim 5, wherein the FX provider is internal to the sending institution; or
wherein the FX provider is external to the sending institution.

7. The computer-implemented method of claim 6, wherein transforming the transfer request includes separating the transfer request into multiple transfer requests based on the amount of the transfer request.

8. The computer-implemented method of claim 1, further comprising verifying the transfer request, based on at least one of: a format, form and/or content of the transfer request, prior to confirming the liquidity of the sending institution.

9. The computer-implemented method of claim 1, wherein the liquidity of the sending institution is specific to an institution located in the second zone; and
further comprising:
prior to receiving the transfer request, funding the liquidity of the sending institution in the second domestic currency with the custodian institution; and/or
replenishing, by the sending institution, the liquidity of the sending institution in the second domestic currency with the custodian institution at one or more intervals.

10. A system for use in cross-border network messaging, the system comprising:
a processor; and
a memory coupled to the processor and including executable instructions, which when executed by the processor cause the processor to:
receive, from a sending institution, a transfer request for a real time transfer from a sender user to a recipient user, the transfer request including an amount to be transferred and an identifier unique to the recipient user, the sending institution located in a first zone having a first domestic currency and the recipient user located in a second zone having a second domestic currency, the amount in the second domestic currency of the second zone;
confirm a liquidity of the sending institution in the first currency with a custodian institution is sufficient to cover the amount included in the transfer request;
in response to the confirmation, transform the transfer request based on one or more rules, the one or more rules specific to the second zone; and
transmit the transformed transfer request to a core computing device located in the second zone, whereby the core computing device provides the transformed transfer request to a recipient institution located in the second zone and associated with the recipient user.

11. The system of claim 10, wherein the identifier unique to the recipient user includes a proxy; and
wherein the executable instructions, when executed by the processor, further cause the processor to:
submit the proxy to a proxy client, thereby permitting the proxy client to submit the proxy to a proxy service core in the first zone to communicate with another proxy service core in the second zone; and
in response to submitting the proxy, receive, from the proxy service core in the first zone, via the proxy client, account data specific to the proxy.

12. The system of claim 10, wherein the identifier unique to the recipient includes account data.

13. The system of claim 10, wherein the identifier unique to the recipient includes a proxy, the proxy including a phone number for the recipient user.

14. The system of claim 10, wherein the executable instructions, when executed by the processor, further cause the processor to:
receive a transfer instruction from the sender user;
in response to the transfer instruction and in connection with a commitment by the sending institution to pre-fund the transfer to the recipient user in the second zone, request a currency conversion quote from a foreign exchange (FX) provider;
receive the currency conversion quote from the FX provider; and
submit the transfer request to the payment system, the amount of the transfer request including an amount of the currency conversion quote.

15. The system of claim 14, wherein the FX provider is internal to the sending institution; or
wherein the FX provider is external to the sending institution.

16. The system of claim 15, wherein the executable instruction, when executed by the processor, cause the processor, in transforming the transfer request, to separate the transfer request into multiple transfer requests based on the amount of the transfer request.

17. The system of claim 10, wherein the executable instructions, when executed by the processor, further cause the processor to verify the transfer request, based on at least one of: a format, form and/or content of the transfer request, prior to confirming the liquidity of the sending institution.

18. The system of claim 10, wherein the liquidity of the sending institution is specific to an institution located in the second zone.
